(19) United States
(12) Patent Application Publication
(10) Pub. No.: US 2024/0334362 A1
(43) Pub. Date: Oct. 3, 2024

(54) AUDIO STREAMING USING RELAY NETWORK

(71) Applicant: Silicon Laboratories Inc., Austin, TX (US)

(72) Inventors: Hasan Ali Stationwala, Hyderabad (IN); Ayan Ghosh, Hyderabad (IN)

(21) Appl. No.: 18/193,928

(22) Filed: Mar. 31, 2023

(51) Int. Cl. H04W 56/00; H04B 7/155

(52) U.S. Cl. CPC H04W 56/0055; H04B 7/15507

(57) ABSTRACT

A relay network of wireless devices extends the range of synchronized playback of broadcast audio signals. A method for delivering isochronous data using a relay network includes receiving first data of an isochronous data stream from a first wireless communications device of the relay network having a first presentation delay. The first data is received by a second wireless communications device of the relay network having a second presentation delay. The method includes presenting the first data by the first wireless communications device and the second wireless communications device at a time after transmission of the first data in a second isochronous data stream by the second wireless communications device. The first data may be presented by each wireless communications device in the relay network after transmission of the first data by a last wireless communications device in the relay network.

### BACKGROUND

### Field of the Invention

This disclosure relates to communications systems in general, and more particularly to radio frequency (RF) communications systems.

### Description of the Related Art

Bluetooth® Low Energy (BLE) is an exemplary communications protocol designed for low power and low latency applications. In general, BLE specifications support isochronous data transactions (e.g., a Connected Isochronous Stream (CIS) or a Broadcast Isochronous Stream (BIS)) and asynchronous data transactions (e.g., Asynchronous Connection Link (ACL) transactions). Isochronous data transactions may be used for latency-sensitive data, i.e., time-bound data for time-synchronized processing (e.g., real time voice or audio streaming) that should be transmitted at a constant rate. The data has a time-limited validity period, at the end of which it is said to expire. Expired data that has not yet been transmitted is discarded. Receiving devices only receive data that is valid with respect to rules regarding its age and acceptable latency. Isochronous data transactions ensure that multiple sink devices, which receive data from the same source, will render the data at the same time. An upper layer of the BLE protocol stack typically uses an isochronous data channel for constant data throughput and periodicity of communication of real time audio data.

Typical audio speakers deliver audio data at a target volume over a limited range. Referring to FIG. 1, to increase the range and provide a uniform loudness experience, additional speakers may be used. In an exemplary audio application, wireless communications devices 112, 122, 172, and 182 each include speakers and are positioned within the range of wireless communications device 102, which also includes a speaker and is the source of broadcast audio data. Wireless communications devices 112, 122, 172, and 182 each establish a BLE connection to wireless communications device 102. Wireless communications device 102 establishes a BIS to wireless communications devices 112, 122, 172, and 182 and specifies a precise time for synchronous playback by wireless communications device 102, and wireless communications devices 112, 122, 172, and 182. However, the BIS from wireless communications device 102 to wireless communications devices 112, 122, 172, and 182 has limited range. Accordingly, improved techniques are for playing back audio data are desired.

### SUMMARY OF EMBODIMENTS OF THE INVENTION

A method for delivering isochronous data using a relay network of wireless communications devices includes receiving first data of an isochronous data stream from a first wireless communications device of the relay network having a first presentation delay. The first data is received by a second wireless communications device of the relay network having a second presentation delay. The method includes presenting the first data by the first wireless communications device and the second wireless communications device at a time after transmission of the first data in a second isochronous data stream by the second wireless communications device. The time is based on the first presentation delay and the second presentation delay. The method may include updating the first presentation delay of the first wireless communications device to generate an updated first presentation delay based on the second presentation delay. The updated first presentation delay may be greater than or equal to a sum of a transmit delay for each wireless communications device in the relay network and the first data may be presented by each wireless communications device in the relay network after transmission of the first data by a last wireless communications device in the relay network.

In at least one embodiment, a relay network of wireless communications devices includes a first wireless communications device having a first presentation delay. The first wireless communications device includes a transmitter circuit configured to transmit first data of an isochronous data stream, a receiver circuit configured to receive a request to increase the first presentation delay of the first wireless communications device based on a second presentation delay of a second wireless communications device in the relay network, data processing circuitry configured to update the first presentation delay to generate an updated first presentation delay based the second presentation delay, and a delivery device configured to present the first data after transmission of the first data by the second wireless communications device in a second isochronous data stream, at a first time based on a first timestamp and the updated first presentation delay.

In at least one embodiment, a relay network of wireless communications devices includes a first wireless communications device having a first presentation delay. The first wireless communications device includes a receiver circuit configured to receive first data of an isochronous data stream from a second wireless communications device in the relay network, a transmitter circuit configured to transmit a request an increase to a second presentation delay of the second wireless communications device, data processing circuitry configured to update the first presentation delay to be an updated first presentation delay based on an updated second presentation delay and the first presentation delay, and a delivery device configured to present the first data after transmission of the first data by the first wireless communications device in a second isochronous data stream, at a time based on a timestamp and the updated first presentation delay.

### BRIEF DESCRIPTION OF THE DRAWINGS

The present invention may be better understood, and its numerous objects, features, and advantages made apparent to those skilled in the art by referencing the accompanying drawings.

FIG. 1 illustrates an exemplary configuration of wireless communications devices including speakers for delivering audio data.

FIG. 2A illustrates a functional block diagram of wireless communications devices of the configuration of FIG. 1.

FIG. 2B illustrates a functional block diagram of an exemplary receiver portion of the wireless communications system of FIG. 2A.

FIG. 2C illustrates a functional block diagram of an exemplary transmitter portion of the wireless communications system of FIG. 2A.

FIG. 3 illustrates a functional block diagram of portions of an exemplary wireless communications device configured for BLE communications and delivery of isochronous data.

FIG. 4 illustrates an exemplary state diagram of a link layer implemented by link controller 212 of FIG. 3.

FIG. 5A illustrates a format of an Asynchronous Connection Link (ACL) packet.

FIG. 5B illustrates a format of a BIS packet.

FIG. 6 illustrates a functional block diagram of a portion of the exemplary wireless communications device of FIG. 3 for delivery of isochronous data.

FIG. 7 illustrates an exemplary configuration of wireless communications devices in a relay network for streaming isochronous data consistent with at least one embodiment of the invention.

FIG. 8 illustrates an exemplary message sequence for a first wireless communications device, a second wireless communications device, and a third wireless communications device in the relay network of FIG. 7 consistent with at least one embodiment of the invention.

FIG. 9 illustrates an exemplary timing diagram for a first wireless communications device configured to deliver isochronous data in the relay network of FIG. 7 consistent with at least one embodiment of the invention.

FIG. 10 illustrates exemplary timing diagrams for a first wireless communications device and a second wireless communications device configured to deliver isochronous data in the relay network of FIG. 7 consistent with at least one embodiment of the invention.

FIG. 11 illustrates exemplary timing diagrams for delivering isochronous data in the relay network of FIG. 7 after updating presentation delay consistent with at least one embodiment of the invention.

FIG. 12 illustrates exemplary timing diagrams for a first wireless communications device, a second wireless communications device, and a third wireless communications device in the relay network of FIG. 7 after updating presentation delay consistent with at least one embodiment of the invention.

FIG. 13 illustrates exemplary timing diagrams for a first wireless communications device, a second wireless communications device, and a third wireless communications device in the relay network of FIG. 7 after further updating presentation delay consistent with at least one embodiment of the invention.

The use of the same reference symbols in different drawings indicates similar or identical items.

### DETAILED DESCRIPTION

A technique for extending the range of a broadcast isochronous stream configures wireless communications devices in a relay network. Updating the presentation delay of a source broadcast source wireless communications device for each additional wireless communications device in the relay network and relaying the isochronous data using additional broadcast isochronous streams between hops of the relay network synchronizes the audio playback by the relay network, reduces or eliminates any perceived echo.

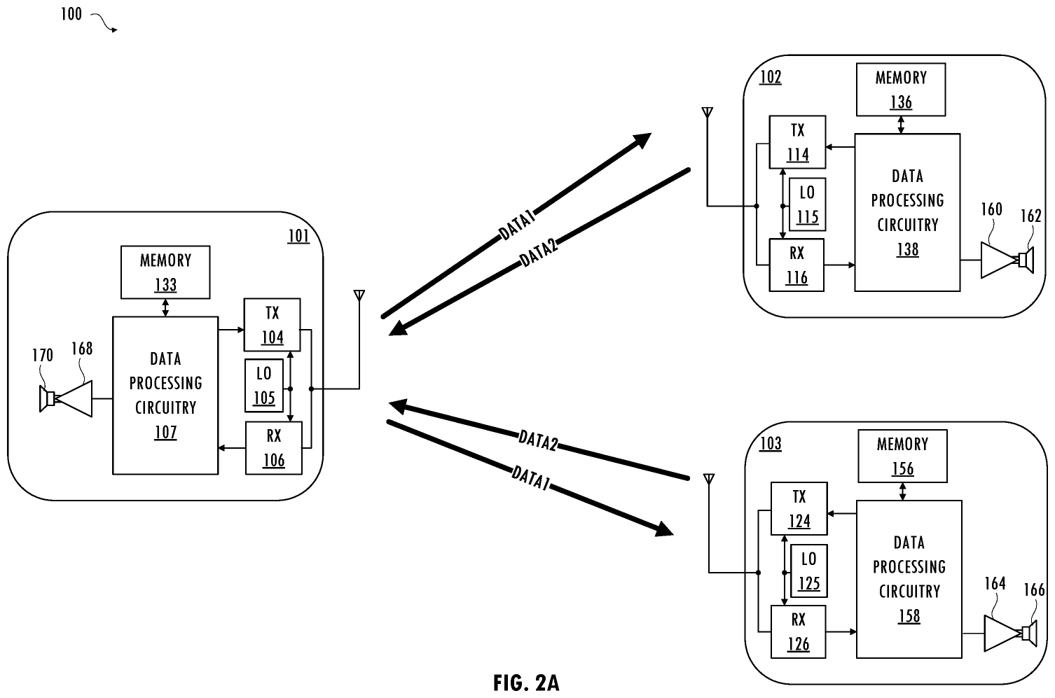

Referring to FIG. 2A, in at least one embodiment, a wireless communications system includes wireless communications device 101, wireless communications device 112, and wireless communications device 103, which are devices compliant with the BLE communications protocol. Wireless communications device 101 includes transmitter 104, receiver 106, data processing circuitry 107, memory 133, and local oscillator 105. Wireless communications device 112 includes transmitter 114, receiver 116, data processing circuitry 138, memory 136, and local oscillator 115. Wireless communications device 103 includes transmitter 124, receiver 126, data processing circuitry 158, memory 156, and local oscillator 125. Wireless communications system 100 is compliant with the Bluetooth Core Specification Version 5.2 or later. Local oscillator 105, local oscillator 115, and local oscillator 125 provide signals used in transceiver functions of wireless communications device 101, wireless communications device 102, and wireless communications device 103, respectively.

In an embodiment of wireless communications system 100, wireless communications device 101, wireless communications device 102, and wireless communications device 103 are BLE audio devices (e.g., wireless speakers or wireless communications devices including speakers) and data processing circuitry 107, data processing circuitry 138, and data processing circuitry 158 provide signals to driver 168, driver 160, and driver 164, respectively, which drive transducer 170, transducer 162, and transducer 166, respectively, to generate audio signals. Additional wireless communications devices (not shown) are similar to wireless communications device 101, wireless communications device 102, and wireless communications device 103.

FIG. 2B illustrates an exemplary embodiment of a receiver that may be included in physical radio of wireless communications device 101, wireless communications device 102, or wireless communications device 103 of FIG. 2A. Referring to FIG. 2B, antenna 109 provides an RF signal to passive network 120, which provides impedance matching, filtering, and electrostatic discharge protection. Passive network 120 is coupled to low-noise amplifier (LNA) 123, which amplifies the RF signal without substantial degradation to the signal-to-noise ratio and provides the amplified RF signal to frequency mixer 127. Frequency mixer 127 performs frequency translation or shifting of the RF signal using a reference or local oscillator (LO) signal provided by local oscillator 115. For example, in at least one operational mode of receiver 116, frequency mixer 127 translates the RF signal from a 2.4 GHz frequency band to baseband frequencies centered at DC (i.e., zero-intermediate frequency (ZIF) in a ZIF mode of operation). In another operational mode, receiver 116 is configured as a low-intermediate frequency (LIF) receiver (i.e., in a LIF mode of operation) and frequency mixer 127 translates the RF signal to a low-intermediate frequency (e.g., 100-200 kHz) to avoid DC offset and 1/f noise problems of ZIF receivers.

Frequency mixer 127 provides the translated output signal as a set of two signals, an in-phase (I) signal, and a quadrature (Q) signal. The I and Q signals are analog time-domain signals. In at least one embodiment of receiver 116, the analog amplifiers and filters 128 provide amplified and filtered versions of the I and Q signals to analog-to-digital converter (ADC) 130, which converts those versions of the I and Q signals to digital I and Q signals (i.e., I and Q samples). Exemplary embodiments of ADC 130 use a variety of signal conversion techniques (e.g., delta-sigma (i.e., sigma-delta) analog to digital conversion). ADC 130 provides the digital I and Q signals to signal processing circuitry 132. In general, signal processing circuitry 132 performs processing (e.g., demodulation, frequency translation (e.g., using mixer 131), filtering (e.g., digital filters 140), or signal correction) of the digital I and Q signals. In at least one embodiment, signal processing circuitry 132 includes demodulator 141, which retrieves or extracts information from digital I and Q signals (e.g., data signals, that were modulated by a transmitter (not shown) and provided to antenna 109 as RF signals). In at least one embodiment, one or more circuits of signal processing circuitry 132 converts digital I and Q signals from a Cartesian representation into polar representation (i.e., instantaneous phase and instantaneous amplitude) for use by frequency correction circuit 142 or phase measurement circuit 143.

Data processing circuitry 138 may perform a variety of functions (e.g., logic, arithmetic, etc.). For example, data processing circuitry 138 may use the demodulated data in a program, routine, or algorithm (whether in software, firmware, hardware, or a combination thereof) to perform desired control or data processing tasks. In at least one embodiment, data processing circuitry 138, which includes memory 136, controls other circuitry, sub-system, or systems (not shown). In an embodiment, data processing circuitry 138 implements a BLE link layer that includes a state machine, defines state transitions, defines packet formats, performs scheduling, performs radio control, and provides link-layer decryption consistent with the BLE protocol.

FIG. 2C illustrates an exemplary embodiment of a transmitter that may be included in a physical radio of wireless communications device 101, wireless communications device 102, or wireless communications device 103 of FIG. 2A. Data processing circuitry 138 of FIG. 2B may perform a variety of functions (e.g., logic, arithmetic, etc.). For example, data processing circuitry 138 executes a program, routine, or algorithm (whether in software, firmware, hardware, or a combination thereof) that performs desired control or data processing tasks consistent with the BLE physical layer and provides data to modulator 150. In an embodiment, modulator 150 implements Gaussian Frequency Shift Keying (GFSK) modulation. Modulator 150 provides the modulated data to transmit baseband circuit 152, which in an embodiment includes a digital-to-analog converter and analog programmable gain filters. Transmit baseband circuit 152 provides the baseband (or intermediate frequency (IF)) signal to frequency mixer 154, which performs frequency translation or shifting of the baseband signal using a reference or local oscillator (LO) signal provided by local oscillator 115. In at least one operational mode of receiver 116, frequency mixer 154 translates the baseband signal centered at DC to a 2.4 GHZ frequency band. Pre-driver 157 amplifies the signal generated by frequency mixer 154 to a level sufficient for power amplifier 159. Power amplifier 159 further amplifies the signal to provide a higher power signal sufficient to drive passive network 120 and antenna 109. Passive network 120 provides impedance matching, filtering, and electrostatic discharge protection.

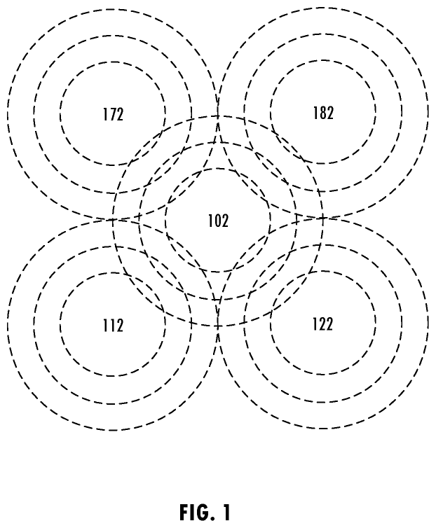

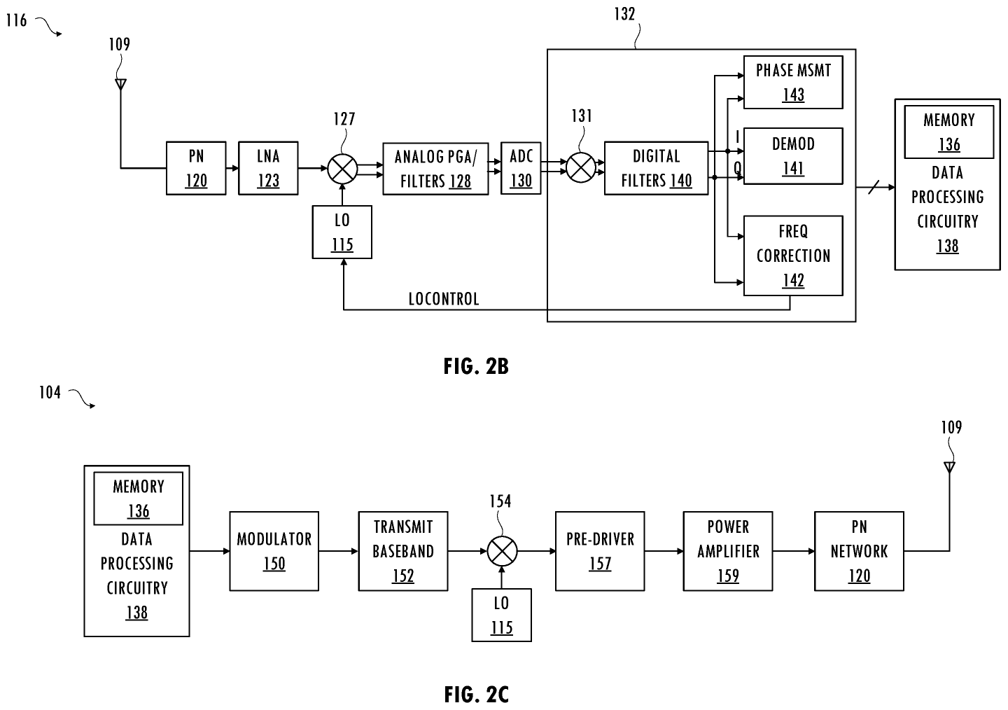

Referring back to FIG. 1, in at least one embodiment of wireless communications device 102, transmitter 114, receiver 116, local oscillator 115, data processing circuitry 138, and memory 136 are included in a controller implementing a link layer of a BLE device and implementing a physical layer (RF and PHY), which controls radio frequency communications. Referring to FIG. 3, each wireless communications device of a BLE communications system implements the BLE architecture, e.g., using separate integrated circuit devices for controller 202 and host 204. In some embodiments, wireless communications device 200 incorporates functionality of controller 202 and host 204 in a single integrated circuit device. Controller 202 includes physical radio (RF) 210 and link controller 212, which are responsible for sending packets over the air by defining the use of a radio, including modulation schemes, frequency bands, channel use, and transmitter and receiver characteristics, e.g., as described in Bluetooth Core Specification Version 5.3, Vol. 6: Low Energy Controller. Physical radio (RF) 210 transmits and receives packets of information using the physical channel and transforms a stream of data to and from the physical channel and the baseband into required formats. The physical layer defines the use of a radio (e.g., the transmitter and receiver described above), including modulation schemes, frequency bands, channel use, and transmitter and receiver characteristics. Link controller 212 implements a link layer protocol, which defines the air interface packet formats, bit stream processing procedures, a state machine and protocols of over-the-air communication, and link control. Link controller 212 encodes and decodes packets from a data payload and parameters related to a physical channel, logical transport, and logical link.

Baseband resource manager 214 negotiates access contracts, i.e., commitments to deliver a predetermined QoS that is required by a user application to provide expected performance. Baseband resource manager 214 also includes a scheduler that grants time on physical channels to entities that have negotiated an access contract. Isochronous Adaptation Layer (ISOAL) 218 converts between upper layer data units and lower layer data units, e.g., using fragmentation and recombination or segmentation and reassembly operations. ISOAL allows the size of isochronous data packets as created and consumed by upper layers of the architecture to be different from the size of data packets used by the link layer. In addition, ISOAL allows an upper layer to use timing intervals that differ from those used by the link layer so that the rate of Service Data Units (SDUs) exchanged with the upper layers is not the same as the rate with which they are exchanged with the link layer. Link manager 216 creates, modifies, and releases logical links (and associated logical transports, if required) and updates parameters related to physical links between devices. In an embodiment, wireless communications device 102 implements Host-to-Controller Interface (HCl) 220, which is a standard service interface.

In an embodiment, host 204 includes Generic Audio Framework (GAF) 206, Logical Link Control and Adaptation Protocol (L2CAP) resource manager 224, Attribute Protocol (ATT) 228, Generic Attribute Protocol (GATT) 232, Generic Access Profile (GAP) 226, and Security Manager (SM) 230. L2CAP resource manager 224 manages ordering of submission of BLE packet protocol data unit (PDU) fragments and some relative scheduling between channels to ensure that L2CAP channels with QoS commitments are not denied access to the physical channel due to controller resource exhaustion. L2CAP resource manager 224 polices traffic to ensure that applications submit L2CAP SDUs within bounds of negotiated QoS settings. In an exemplary wireless communications device 200, GATT 232 defines the way that two BLE devices communicate data using services and characteristics. In an embodiment, GATT 232 uses a generic data protocol stored in ATT 228, which is used to store services, characteristics and related data in a simple lookup table using 16-bit identifiers for each entry in the table. SM 230 implements a peer-to-peer protocol for generating encryption keys and identity keys and generates random addresses and resolves random addresses to known device identities. SM 230 provides stored keys to controller 202 for encryption and authentication during encryption or pairing procedures.

GAP 226 represents base functionality common to all Bluetooth devices, e.g., modes and access procedures used by transports, protocols, and application profiles. GAP services include device discovery, connection modes, security authentication, associate models and service discovery. GAF 206 includes Script and API 234, application 238, and profiles 236, which adds application specific information to GAF 206. For example, profiles 236 includes an audio profile, e.g., as described in Basic Audio Profile (BAP), Bluetooth Profile Specification V1.0 2021-09-14 (herein after the “BAP specification”), which defines procedures for controlling audio streams by using GATT 232 and GAP 226 for devices that use BLE in audio-related scenarios (e.g., sending or receiving unicast audio or sending or receiving broadcast audio). For example, the BAP works with other stream control specifications (e.g., Published Audio Capabilities Service (PACS), Audio Stream Control Service (ASCS), and Broadcast Audio Scan Service (BASS)) to set up and manage unicast and broadcast audio streams, e.g., using an application layer state machine for each individual isochronous channel that transitions between idle, configured, and streaming states. In an embodiment, profiles 236 also includes telephony and media audio profile (TMAP), which specifies higher quality codec settings and more complex media and telephony control, and profiles 236 includes public broadcast profile (PBP), which facilitates selecting globally interoperable broadcast systems.

Low complexity communications codec (LC3) 222 includes a codec for high performance telephony speech, wideband and super-wideband speech, and high-quality audio. LC3 222 encodes audio data into different channel streams (e.g., stereo is encoded as separate left and right streams). LC3 222 provides audio data as SDUs to the link layer, which generates PDUs for isochronous data streams. The link layer provides SDUs based on received PDUs to LC3 222 for decoding.

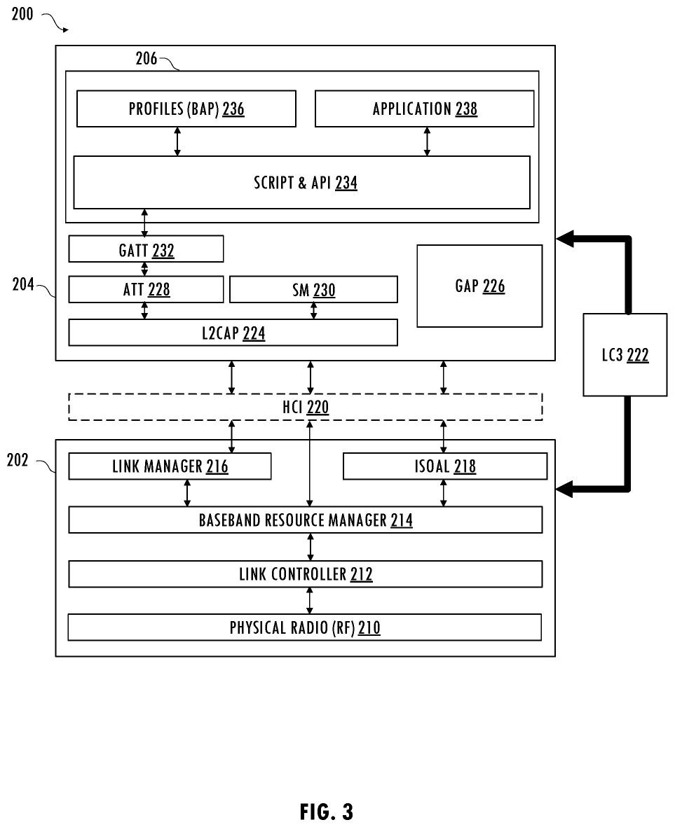

FIG. 4 illustrates an exemplary state machine implemented by the link layer of wireless communications device 200 including standby state 402, scanning state 404 or advertising state 406, initiating state 408, synchronization state 410, connection state 412, and isochronous broadcasting state 414. Only one state of the link layer is active at a time. Link layer state machine 400 can enter standby state 402 from any other state. In standby state 402, the link layer does not transmit any packets. Link layer state machine 400 may enter advertising state 406 from standby state 402. In advertising state 406, the link layer transmits advertising physical channel packets and may listen to and respond to a response triggered by the advertising physical channel packets. In at least one embodiment, the link layer transmits periodic advertising PDUs, which expose broadcast audio stream parameters, including presentation delay.

Link layer state machine 400 may enter scanning state 404 from standby state 402. In scanning state 404, the link layer listens for advertising physical channel packets from devices that are advertising. Link layer state machine 400 may enter initiating state 408 from standby state 402. In initiating state 408, the link layer listens for advertising physical channel packets from a specific device and responds to these packets to initiate a connection. Link layer state machine 400 may enter synchronization state 410 from standby state 402. In synchronization state 410, the link layer listens for periodic channel packets forming a specific periodic advertising train transmitted by a specified device (e.g., a host may direct the link layer to listen for isochronous data packets coming from a specified device that is transmitting a broadcast isochronous group (BIG)). Link layer state machine 400 may enter isochronous broadcasting state 414 from standby state 402. In isochronous broadcasting state 414, the link layer transmits isochronous data packets on an isochronous physical channel.

Link layer state machine 400 may enter connection state 412 from initiating state 408 or advertising state 406. When entering connection state 412 from initiating state 408, the connection state is the central role (i.e., the wireless communications device is configured as a central device) and the wireless communications device communicates with another wireless communications device having a connection state of a peripheral role (i.e., the other wireless communications device is configured as a peripheral device) and defines the timings of transmissions. When entering connection state 412 from advertising state 406, the connection state is the peripheral role and the link layer communicates with a single other wireless communications device configured in the central role. In some embodiments, during connection state 412, the link layer transmits data physical channel PDUs in connection events. A connection event typically contains at least one packet sent by the central device. The same data channel index is used for all packets in a connection event. In some embodiments, during a connection event, the central device and peripheral device alternate sending and receiving packets.

In an embodiment, the link layer uses one physical channel (RF channel) at a time. Each transmission on a physical channel is associated with corresponding access address. In general, two wireless communications devices use a shared physical channel to communicate with each other. Whenever the link layer of a wireless communications device is synchronized to the timing, frequency, and access address of a physical channel, the link layer is connected on the data physical channel or synchronized to a periodic physical channel or an isochronous physical channel regardless of whether it is actively involved in communications over the channel.

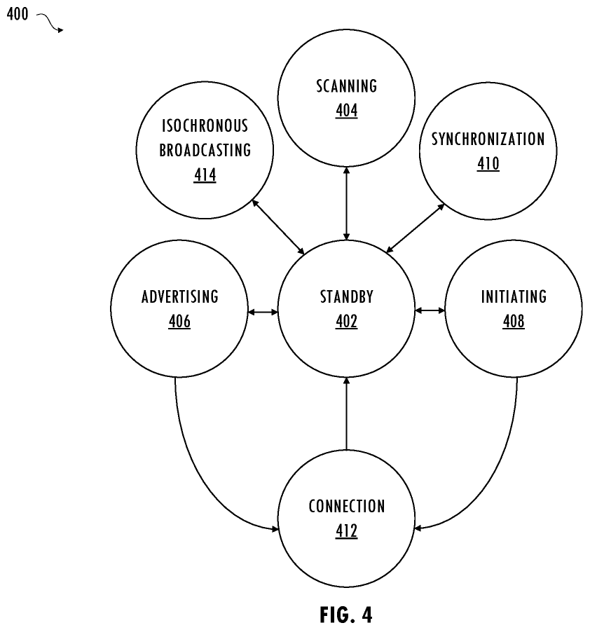

FIG. 5A illustrates an exemplary BLE ACL radio packet for transmitting data by a wireless communications device. Packet 302 includes preamble 304 (e.g., 1 or 2 octets), access address 306 (e.g., 4 octets), PDU 308 (e.g., 2-257 octets) and cyclic redundancy check (CRC) 310 (e.g., 3 octets). PDU 308 includes header 312 (e.g., 16 bits), payload 314 (e.g., 0-251 octets), and an optional Message Integrity Check (e.g., 32 bits). Header 312 includes seven or eight fields: LLID indicates the type of content of the payload field of the PDU, e.g., whether the packet is a link layer data PDU or a link layer control PDU (e.g., 2 bits), Next Expected Sequence Number (e.g., 1 bit), Sequence Number (1 bit), More Data (e.g., 1 bit), CTEInfo Present (e.g., 1 bit), Reserved for Future Use bits (e.g., 2 bits), Length (e.g., 8 bits), and CTEInfo indicating a type and length of a Constant Tone Extension (if present, e.g., 8 bits).

FIG. 5B illustrates an exemplary BLE BIS radio packet for transmitting data by a wireless communications device. BIS packet 502 includes preamble 504, access address 506, isochronous PDU 508, and CRC 510, which are similar to the corresponding fields of a CIS packet described above. In addition, header 512, payload 514, and the optional MIC field are similar to the corresponding fields in the CIS packet. However, BIS packet 502 has a simpler header since the SN and NESN flow control bits are not needed for BIS packets. Header 512 includes Link Layer ID (e.g., 2 bits), Control Subevent Sequence Number (e.g., 3 bits), Control Subevent Transmission Flag (e.g., 1 bit), Reserved for Future Use bits (e.g., 2 bits), and Length (e.g., 8 bits). The CSTF bit signals that a control subevent is present in that BIS event. The control subevent provides control information to every sink device and is used to inform the sink device of events such as a change in hopping sequence.

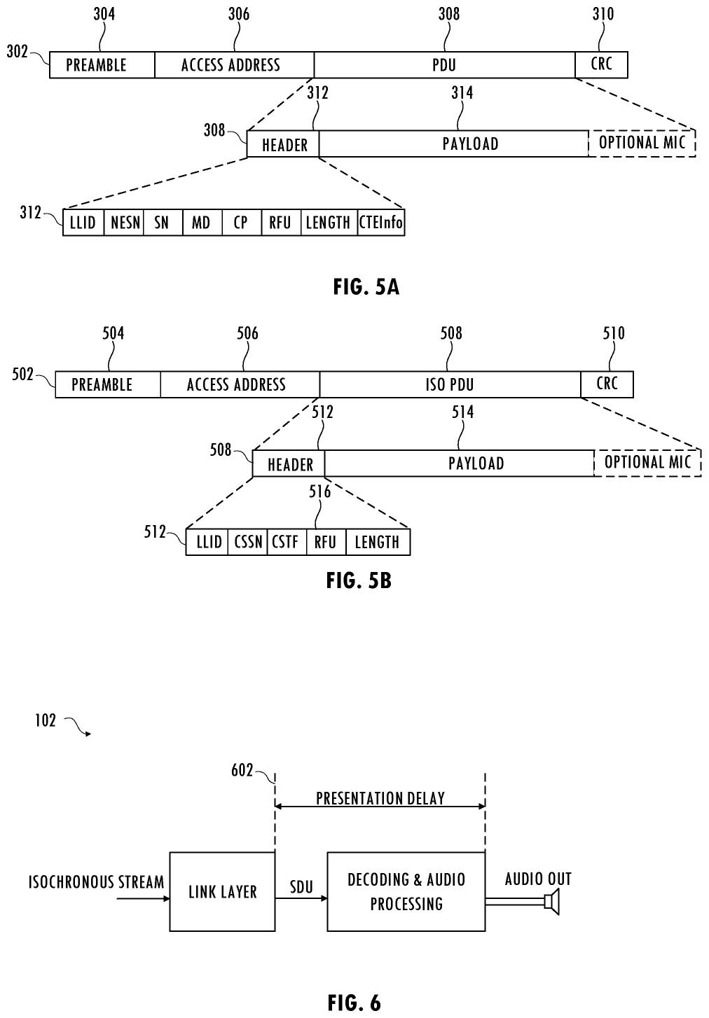

Referring to FIG. 6, in at least one embodiment, wireless communications device 102 is a broadcast audio source of a BIS and sets a presentation delay parameter value in a Broadcast Audio Source Endpoint (BASE) in an audio announcement (e.g., a Basic Audio Announcement of the Basic Audio Profile) used to inform scanning devices of parameters of a BIS. The presentation delay parameter controls the precise timestamp at which isochronous data (e.g., audio data) is to be delivered (e.g., played back) after reception. Wireless communications device 102 sets the presentation delay parameter to a value that is expected to be in a range of capabilities of all broadcast sinks expected to synchronize to a BIS broadcast from wireless communications device 102. The value includes any implementation specific delays in a broadcast sink device, e.g., processing time for internal transports, codec processing. ADC/DAC delays, application-specific audio processing, or other system delay of wireless communications device 102, 122, 172, or 182. For example, wireless communications device 102 sets the presentation delay to a time when audio data is to be played back by every wireless communications device, e.g., a time in microseconds after a timestamp corresponding to synchronization point 602. In at least one embodiment, synchronization point 602 is the SDU Synchronization Reference of the BAP specification. In at least one embodiment the presentation delay is specified using three octets ranging from 0 to 16.7 sec in μs (0x000000 to Oxffffff). In at least one embodiment, wireless communications device 102 reads a minimum and maximum presentation delay of a broadcast sink device (e.g., wireless communications device 102, 122, 172, or 182) during configuration and sets a presentation delay value to be greater than the highest presentation delay minimum of the broadcast sink devices and lower than the lowest presentation delay maximum of broadcast sink devices listening to a broadcast from wireless communications device 102.

A technique extends the range of synchronized delivery of isochronous data (e.g., playback of broadcast audio signals) beyond the range of a source wireless communications device (e.g., a source BLE audio device) by configuring multiple wireless communications devices (e.g., multiple BLE audio devices) in a relay network and increasing the presentation delay of the source wireless communications device by an amount that includes a presentation delay of each additional broadcasting wireless communications device in the relay network. The mechanism relays the isochronous data across multiple hops and updates corresponding presentation delays such that the isochronous data is delivered (e.g., played back) at a precise instant on all wireless communications devices in the relay network, regardless of the number of hops between a source wireless communications device and a final wireless communications device of the relay network that delivers the isochronous data.

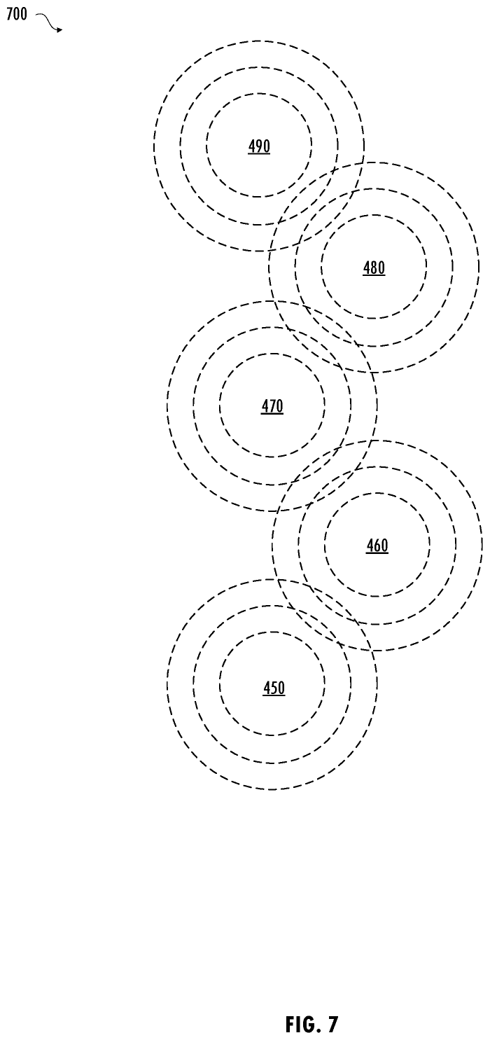

Referring to FIG. 7, in at least one embodiment, wireless communications device 450 is a broadcast source of a BIS and forms relay network 700 with wireless communications devices 460, 470, 480, and 490, which are configured as broadcast sources that broadcast corresponding BIS and as broadcast sinks that play back buffered audio data of broadcast audio streams. Wireless communications devices 450, 460, 470, 480, and 490 have features of the wireless communications devices described above. Relay network 700 is configured to relay audio data received in a BIS by one wireless communications device from a broadcast source device to a next wireless communications device (e.g., configured as the broadcast sink device) in the relay network and adjusting the presentation delay associated with each BIS to account for multiple hops so that the audio is played back at the same time on wireless communications devices 450, 460, 470, 480, and 490, after the last wireless communications device (e.g., wireless communications device 490) in the relay network broadcasts a corresponding BIS, regardless of the number of hops between wireless communications device 450 and the last wireless communications device in the relay network (e.g., wireless communications device 490).

In at least one embodiment, wireless communications device 460 is the only wireless communications device within range of wireless communications device 450 and serves as a broadcast sink device for the BIS broadcast by wireless communications device 450. Therefore, wireless communications device 450 sets a presentation delay parameter value to be greater than the highest presentation delay minimum of wireless communications device 460 and lower than the lowest presentation delay maximum of wireless communications device 460. Wireless communications device 450 informs wireless communications device 460 of the selected presentation delay. In at least one embodiment, before wireless communications device 460 relays (e.g., broadcasts) data received from wireless communications device 450 to a next wireless communications device to form a relay network, wireless communications device 460 requests an update to the presentation delay (e.g., by an amount equal to the presentation delay of wireless communications device 460) using periodic advertisements of a BIS. In at least one embodiment, wireless communications device 460 provides the request to update the presentation delay using GATT transactions.

In general, a broadcast source device (e.g., wireless communications device 450) is aware of all other wireless communications devices in the relay network receiving audio data from the source device and increases its presentation delay to accommodate the presentation delay of each hop or level of wireless communications devices included in the relay network. In response to a request to increase the presentation delay receive directly or indirectly from another wireless communications device in the relay network, the broadcast source device updates presentation delay in the BASE information, which is transmitted in periodic advertisements to each broadcast sink device directly or indirectly from the broadcast source device. Each broadcast sink device reduces a corresponding received updated presentation delay to accommodate the broadcast sink device presentation delay and then communicates that updated presentation delay to a next broadcast sink device in the relay network (e.g., in the BASE information, which is transmitted in periodic advertisements to each broadcast sink device within range of the broadcast sink device).

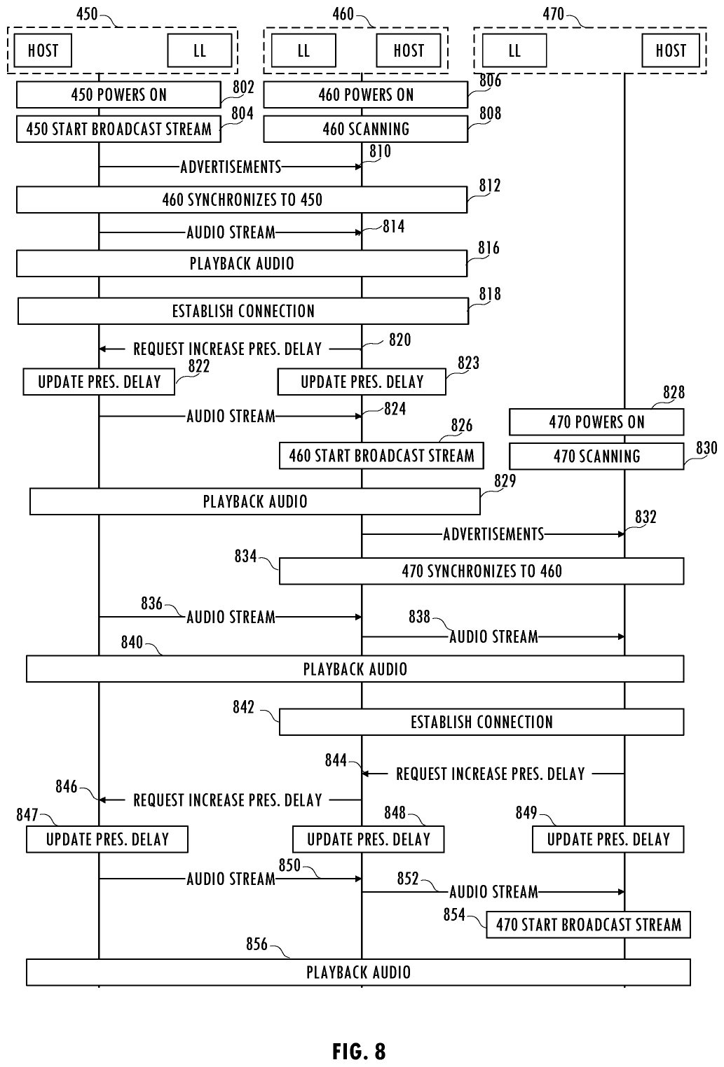

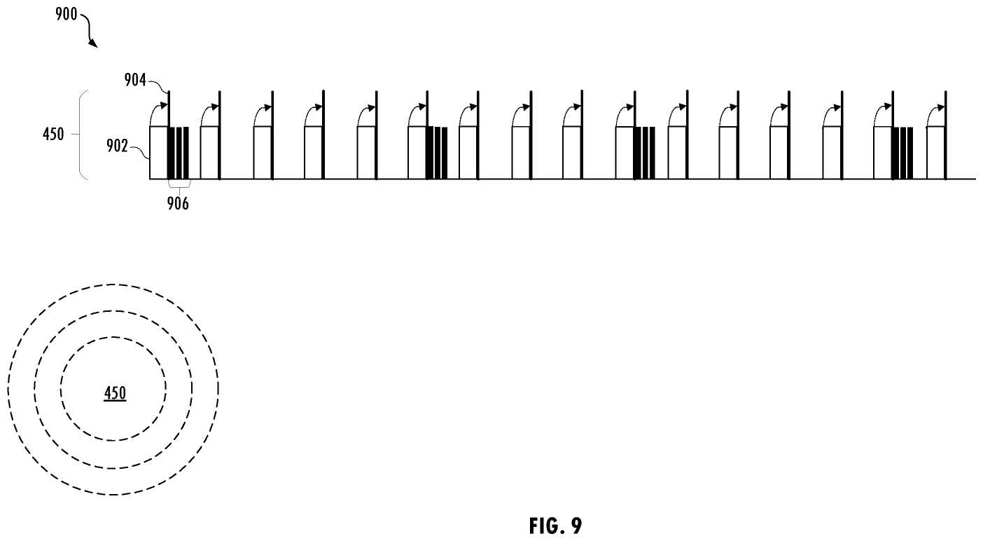

Referring to FIGS. 7 and 8, configuration of relay network 700 begins when wireless communications device 450 powers on (802) and wireless communications device 450 starts to broadcast an isochronous stream (804). Wireless communications device 460 also powers on (806) and enters a scanning state (808). FIG. 9 illustrates BIS 900, which is an exemplary broadcast isochronous stream that includes transmit BIS 902 of audio data at periodic intervals, advertising transmissions 906 at periodic intervals, and audio playback points 904 at periodic intervals, which occur after a presentation delay of wireless communications device 450. In an embodiment, a total system delay is the sum of Audio Processing Time, Transport Latency, and Presentation Delay, as described above. Advertising transmissions 906 are used by another wireless communications device (e.g., a BLE audio device) in a scanning state within range of wireless communications device 450 to tune to the other wireless communications device to receive broadcast transmissions from wireless communications device 450.

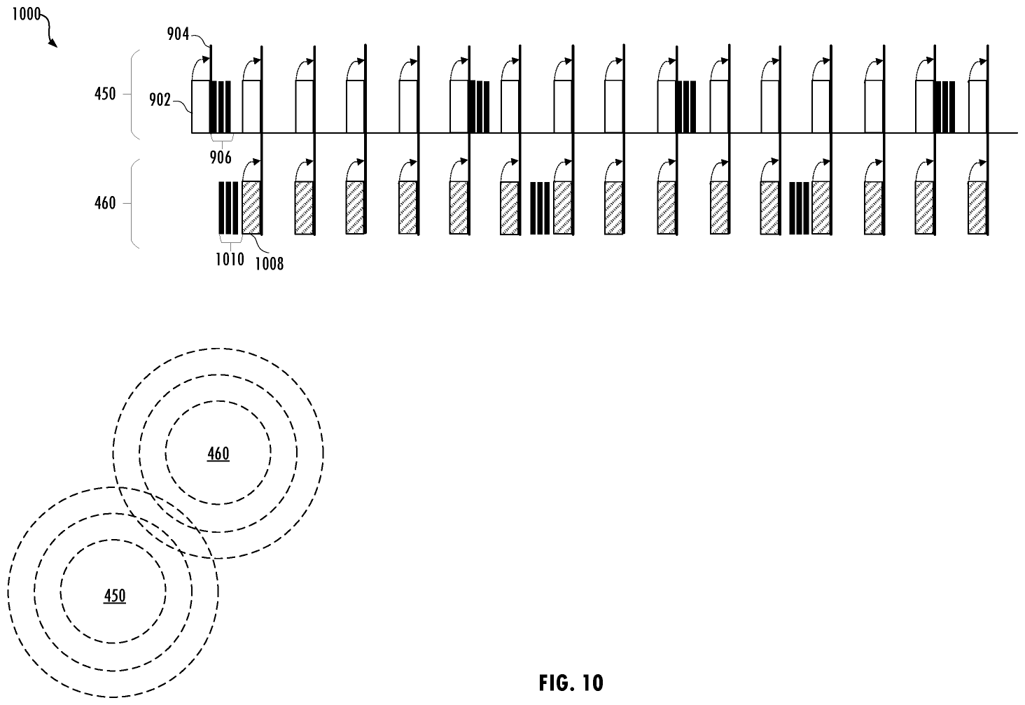

Referring back to FIGS. 7 and 8, wireless communications device 460 detects advertisements from wireless communications device 450 (810) and synchronizes to wireless communications device 450 (812). Accordingly, wireless communications device 460 receives a BIS (e.g., an audio stream) from wireless communications device 450 (814). Wireless communications devices 450 and 460 playback the audio data synchronously (816) at the audio playback point based on a corresponding timestamp and presentation delay of each of wireless communications devices 450 and 460. Referring to FIG. 10, wireless communications device 460 generates advertisements 1010, receives the audio data from wireless communications device 450 in receive BIS 1008, and wireless communications devices 450 and 460 playback the audio data at audio playback points 904.

Referring back to FIGS. 7 and 8, wireless communications device 460 establishes a connection with wireless communications device 450 (818) and indicates to wireless communications device 450 that wireless communications device 460 will relay the audio data to another wireless communications device within range of wireless communications device 460 (e.g., wireless communications device 470) and thus, requests an increase to the presentation delay to accommodate a transmit system delay associated with relaying the audio data by wireless communications device 460 to another BLE audio device in a corresponding BIS. Wireless communications device 460 may use an ACL packet or an extended advertising packet to request the increase to the presentation delay (820). In a conventional BLE audio system, any change to presentation delay requires an associated BIS/BIG to be terminated and the configuration process to be restarted. In at least one embodiment, wireless communications device 450 increases its presentation delay by a predetermined amount (e.g., an amount communicated of the presentation delay of wireless communications device 460 communicated by wireless communications device 460 to wireless communications device 450 in an ACL packet or an extended advertising PDU) (822). Wireless communications device 450 transmits its updated presentation delay to wireless communications device 460, e.g., using periodic advertisements. Wireless communications device 460 receives the updated presentation delay and reduces it by a corresponding amount for another BIS (823). Wireless communications device 450 transmits that audio data to wireless communications device 460 (i.e., broadcasts audio data to wireless communications device 460) (824) and wireless communications device 460 begins to transmit that audio data in another BIS (826).

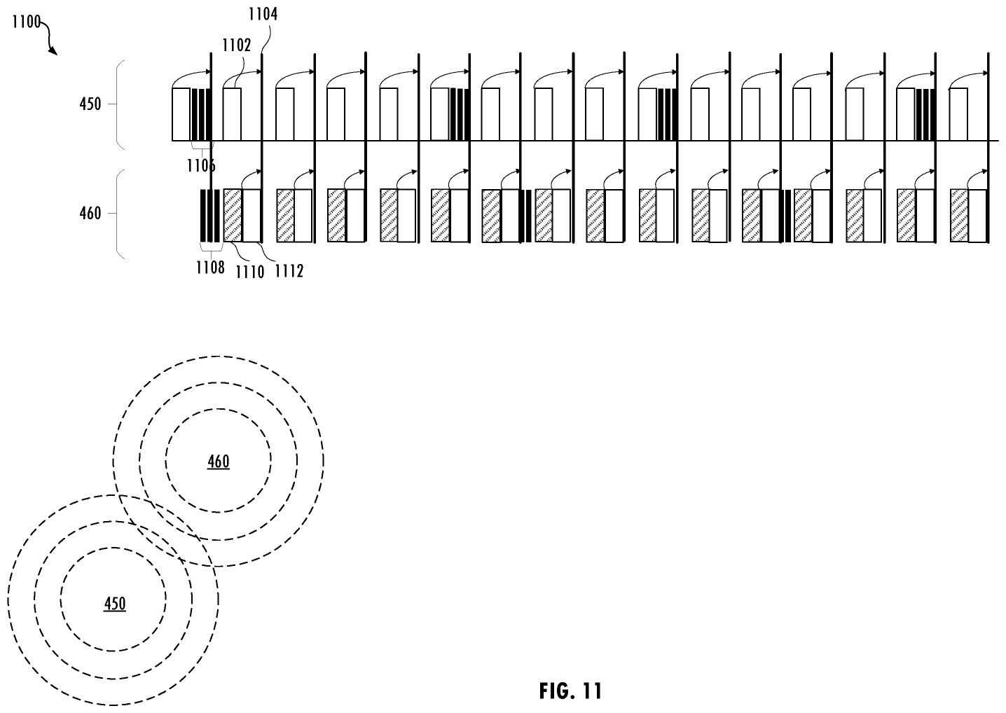

As illustrated in FIG. 11, audio data streams 1100 are associated with an updated presentation delay that provides sufficient time for wireless communications device 450 to transmit audio data as transmit BIS 1102 and send periodic advertisements 1106, wireless communications device 460 to receive audio data as receive BIS 1110, and wireless communications device 460 to relay that audio data as transmit BIS 1112 prior to playback point 1104. Meanwhile, wireless communications device 460 sends periodic advertisements 1108. Referring to FIGS. 7 and 8, wireless communications device 470 powers on (828) and begins scanning (830). Wireless communications devices 450 and 460 playback the audio data synchronously (829) at the audio playback point, which is after wireless communications device 460 broadcasts the audio data, at a time based on a timestamp and an updated presentation delay based on the presentation delay of each wireless communications device.

Wireless communications device 470 receives advertisements from wireless communications device 460 (832). Wireless communications device 470 synchronizes to wireless communications device 460 (834). Wireless communications device 450 transmits an audio stream to wireless communications device 460 (836) and wireless communications device 460 receives that audio stream and relays it to wireless communications device 470 (838). Wireless communications devices 450, 460, and 470 playback the audio data synchronously according to corresponding updated presentation delays at the audio playback point, which is after wireless communications device 460 broadcasts the audio data, at a time based on a corresponding timestamp and presentation delay of each wireless communications device (840).

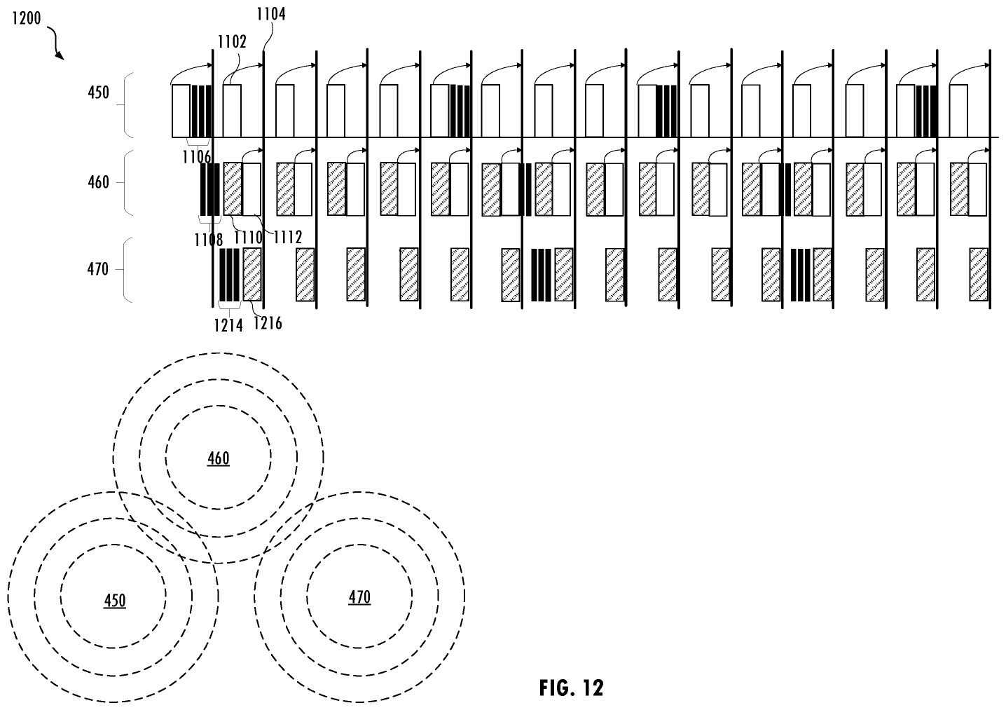

Referring to FIG. 12, communications streams 1200 have sufficient time for wireless communications device 450 to transmit audio data as transmit BIS 1102, wireless communications device 460 to receive the audio data as receive BIS 1110, and for wireless communications device 460 to relay the received audio data as transmit BIS 1112 to wireless communications device 470. Wireless communications device 470 receives the relayed audio data as receive BIS 1216 and sends periodic advertisements 1214. The updated presentation delays provide sufficient time to transmit audio data as transmit BIS 1102, wireless communications device 460 to receive the audio data as receive BIS 1110, and for wireless communications device 460 to relay that audio data in transmit audio data 1112 prior to playback point 1104. However, the updated presentation delays are insufficient to accommodate relay of the audio data by wireless communications device 470 to another wireless communications device.

Accordingly, referring to FIGS. 7 and 8 wireless communications device 470 establishes a regular low energy connection with wireless communications device 460 (842) and requests that wireless communications device 460 increase the presentation delay to accommodate the presentation delay of wireless communications device 470 (844). Wireless communications device 460 relays that request back to wireless communications device 450 (846). Wireless communications device 450 further updates the presentation delay by the presentation delay of wireless communications device 470 and transmits the updated presentation delay to wireless communications device 460, e.g., using periodic advertisements (847). Wireless communications device 460 receives the updated presentation delay and further updates it to reference synchronization point of wireless communications device 460 and transmits a corresponding updated presentation delay to wireless communications device 470 (848). Wireless communications device 470 receives the updated presentation delay and further updates it to reference a corresponding synchronization point of wireless communications device 470 (849).

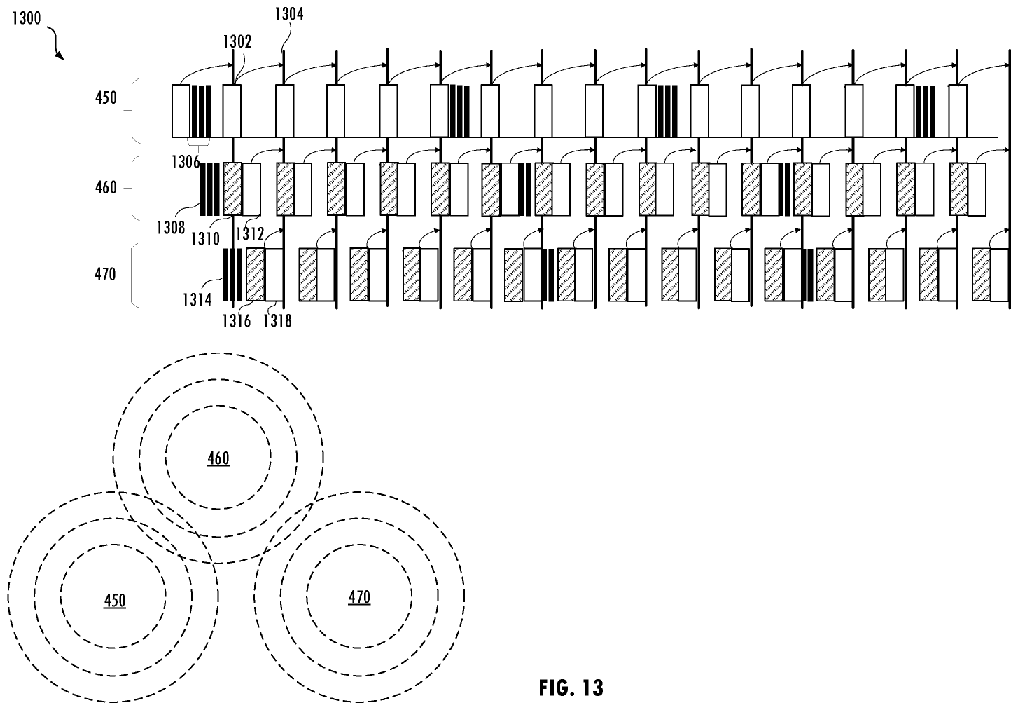

Wireless communications device 450 broadcasts an audio stream that is received by wireless communications device 460 (850) and wireless communications device 460 relays the received audio data to wireless communications device 470 in another BIS (852). Wireless communications device 470 begins to broadcast a BIS of the audio data (854). Wireless communications devices 450, 460, and 470 playback the audio data synchronously at the audio playback point, which is after wireless communications device 470 broadcasts the audio data. Each of wireless communications devices 450, 460, and 470 play back the audio data at a time based on a corresponding timestamp and a further updated presentation delay (856). Referring to FIG. 13, communications streams 1300 provide sufficient time for wireless communications device 450 to transmit audio data in transmit BIS 1302, wireless communications device 460 to receive the audio data in receive BIS 1310, and for wireless communications device 460 to relay that audio data to wireless communications device 470 in transmit BIS 1312. Wireless communications device 450 transmits periodic advertisements 1306, wireless communications device 460 transmits periodic advertisements 1308, and wireless communications device 470 transmits periodic advertisements 1314. Wireless communications device 470 has sufficient time to broadcast the received audio stream 1316 in transmit audio stream 1318 prior to audio playback points 1304.

Messaging of FIG. 8 can be extended to sequentially configure wireless communication devices 480 and 490 in relay network 700. Each additional wireless communications device in relay network 700 sends a request to increase to the presentation delay of the source wireless communications device to an adjacent wireless communications device in relay network 700 and performs a corresponding update to a presentation delay subsequently received from the adjacent wireless communications device before starting a corresponding BIS and playing back the audio data in synchrony with the other wireless communications device in relay network 700. Each wireless communications device(n) of the relay network receives audio data that originated at a source device of the relay network and plays pack that audio data at the same time, which is computed at each wireless communications device(n) a time(n)=synchronization point(n)+presentation delay(n), where synchronization point(n) is the synchronization point of wireless communications device(n) (e.g., the SDU synchronization reference of a corresponding BIS).

In an exemplary embodiment of relay network 700, wireless communications device 450 is a broadcast source device and wireless communications device 460, wireless communications device 470, wireless communications device 480, and wireless communications device 490 are sequentially configured as part of relay network 700, and wireless communications device 490 is the last wireless communications device in relay network 700. If each wireless communications device in relay network 700 has a presentation delay of 5 ms, in steady state (i.e., after wireless communications devices 460, 470, 480, and 490 each directly or directly request an update to the presentation delay of the source wireless communications node and started a BIS) the updated presentation delay of wireless communications device 450 is 25 ms. Wireless communications device 460 receives that updated presentation delay from wireless communications device 450 and decrements it by the presentation delay of wireless communications device 460 to determine an updated presentation delay of wireless communications device 460 of 20 ms and wireless communications device 460 communicates its updated presentation delay to wireless communications device 470. Wireless communications device 470 receives the updated presentation delay of wireless communications device 460 and decrements it by the presentation delay of wireless communications device 470 to determine an updated presentation delay of wireless communications device 470 of 15 ms and wireless communications device 470 communicates its updated presentation delay to wireless communications device 480. Wireless communications device 480 receives that updated presentation delay from wireless communications device 470 and decrements it by the presentation delay of wireless communications device 480 to determine an updated presentation delay of wireless communications device 480 of 10 ms and wireless communications device 480 communicates its updated presentation delay to wireless communications device 490. Wireless communications device 490 receives that updated presentation delay from wireless communications device 480 and decrements it by the presentation delay of wireless communications device 490 to determine an updated presentation delay of wireless communications device 490 of 5 ms. Although the presentation delay of each wireless communications device is FIG. 7 is described as having the same length of time, in other embodiments, each wireless communications device may have a different value for the presentation delay.

In some embodiments of a relay network for audio streaming, a request to increase the presentation delay is relayed from a last wireless communications device to a first (i.e., source) wireless communications device using ACL connections between wireless communications devices in the relay network. In other embodiments the request is relayed serially using continuous advertising. In an embodiment, a first wireless communications device detects a requested increase to presentation delay associated with the transmit path of another wireless communications device in the advertisement or ACL packet and adds that requested increase to a presentation delay of the source wireless communications device and the presentation delay of intervening wireless communications devices. A source device communicates its updated presentation delay directly or indirectly to the other wireless communications devices in the relay network. Additional wireless communications devices may be added to the relay network and each additional wireless communications device extends the range of the relay network.

Thus, techniques that extend the range of synchronized playback of broadcast audio signals beyond the range of a source BLE audio device by configuring multiple BLE audio devices in a relay network and delaying the playback point by an amount based on the presentation delay of each additional wireless communications device in the relay network that broadcasts the isochronous data to a next wireless communications device in the relay network have been described. The techniques may be implemented using software executing on a processor (which includes firmware) or by a combination of software and hardware. Software, as described herein, may be encoded in at least one tangible (i.e., non-transitory) computer readable medium. As referred to herein, a tangible computer-readable medium includes at least a disk, tape, or other magnetic, optical, or electronic storage medium.

The description of the invention set forth herein is illustrative and is not intended to limit the scope of the invention as set forth in the following claims. For example, while the invention has been described in an embodiment in a BLE audio system delivering audio data, one of skill in the art will appreciate that the teachings herein can be utilized with communications of other types of isochronous data and delivery devices (e.g., video being delivered by a display) or combinations thereof. The terms “first,” “second,” “third,” and so forth, as used in the claims, unless otherwise clear by context, is to distinguish between different items in the claims and does not otherwise indicate or imply any order in time, location, or quality. For example, “a first received signal,” “a second received signal,” does not indicate or imply that the first received signal occurs in time before the second received signal. Variations and modifications of the embodiments disclosed herein may be made based on the description set forth herein, without departing from the scope of the invention as set forth in the following claims.

What is claimed is:

1. A method for delivering isochronous data using a relay network of wireless communications devices, the method comprising:
receiving first data of an isochronous data stream from a first wireless communications device of the relay network having a first presentation delay, by a second wireless communications device of the relay network having a second presentation delay; and
presenting the first data by the first wireless communications device and the second wireless communications device at a time after transmission of the first data in a second isochronous data stream by the second wireless communications device, the time being based on the first presentation delay and the second presentation delay.

2. The method as recited in claim 1, further comprising:
updating the first presentation delay of the first wireless communications device to generate an updated first presentation delay based on the second presentation delay.

3. The method as recited in claim 2 wherein the updated first presentation delay is greater than or equal to a sum of a transmit delay for each wireless communications device in the relay network and the first data is presented by each wireless communications device in the relay network after transmission of the first data by a last wireless communications device in the relay network.

4. The method as recited in claim 2, further comprising:
further updating the updated first presentation delay to generate a further updated presentation delay based on a third presentation delay of a third wireless communications device in the relay network.

5. The method as recited in claim 4, further comprising:
receiving second data of the isochronous data stream by the second wireless communications device from the first wireless communications device;
transmitting the second data in the second isochronous data stream by the second wireless communications device;
receiving the second data by the third wireless communications device from the second wireless communications device; and
presenting the second data by each wireless communications device of the relay network at a second time after transmission of the second data by the third wireless communications device.

6. The method as recited in claim 4 further comprising:
indicating the third presentation delay by the third wireless communications device to the second wireless communications device; and
indicating the third presentation delay by the second wireless communications device to the first wireless communications device.

7. The method as recited in claim 1 further comprising:
indicating the second presentation delay to the first wireless communications device in an advertising packet sent by the second wireless communications device.

8. The method as recited in claim 1, further comprising:
indicating the second presentation delay in a packet sent by the second wireless communications device to the first wireless communications device.

9. The method as recited in claim 1, wherein the first data is audio data, the first data is presented by a speaker, and the isochronous data stream is a broadcast isochronous stream of a Bluetooth Low Energy communications interface.

10. A relay network of wireless communications devices, the relay network comprising:
a first wireless communications device having a first presentation delay, the first wireless communications device comprising:
a transmitter circuit configured to transmit first data of an isochronous data stream;
a receiver circuit configured to receive a request to increase the first presentation delay of the first wireless communications device based on a second presentation delay of a second wireless communications device in the relay network;
data processing circuitry configured to update the first presentation delay to generate an updated first presentation delay based the second presentation delay; and
a delivery device configured to present the first data after transmission of the first data by the second wireless communications device in a second isochronous data stream, at a first time based on a first timestamp and the updated first presentation delay.

11. The relay network as recited in claim 10, further comprising:
the second wireless communications device in the relay network, the second wireless communications device comprising:
a second transmitter circuit configured to transmit the first data in the second isochronous data stream and to transmit the request; and
a second receiver circuit configured to receive the first data; and
second data processing circuitry configured to generate an updated second presentation delay based on the updated first presentation delay and the second presentation delay; and
a second delivery device configured to present the first data after transmission of the first data by the second wireless communications device at the first time based on a second timestamp and the updated second presentation delay.

12. The relay network as recited in claim 11, further comprising:
a third wireless communications device in the relay network, the third wireless communications device comprising:
a third transmitter circuit configured to transmit the first data in a third isochronous data stream and a second request to increase the second presentation delay by a third presentation delay of the third wireless communications device; and
a third receiver circuit configured to receive first data in the second isochronous data stream; and
third data processing circuitry configured to generate an updated third presentation delay based on the updated second presentation delay and the third presentation delay; and
a third delivery device configured to present the first data after transmission of the first data by the third wireless communications device at the first time based on a third timestamp and the updated third presentation delay.

13. The relay network as recited in claim 10 wherein the data processing circuitry comprises:
a storage element; and
a processor configured to execute instructions stored in the storage element, the instructions being executable by the processor to cause the processor to generate the updated first presentation delay based on the first presentation delay and the second presentation delay.

14. The relay network as recited in claim 10 wherein the updated first presentation delay is greater than or equal to a sum of a transmit delay for each wireless communications device in the relay network and the first data is presented by each wireless communications device in the relay network after transmission of the first data by a last wireless communications device in the relay network.

15. The relay network as recited in claim 10 wherein the first data is audio data, the delivery device is a speaker, and the isochronous data stream is a broadcast isochronous stream of a Bluetooth Low Energy communications interface.

16. A relay network of wireless communications devices comprising:
a first wireless communications device having a first presentation delay and comprising:
a receiver circuit configured to receive first data of an isochronous data stream from a second wireless communications device in the relay network;
a transmitter circuit configured to transmit a request an increase to a second presentation delay of the second wireless communications device;
data processing circuitry configured to update the first presentation delay to be an updated first presentation delay based on an updated second presentation delay and the first presentation delay; and
a delivery device configured to present the first data after transmission of the first data by the first wireless communications device in a second isochronous data stream, at a time based on a timestamp and the updated first presentation delay.

17. The relay network as recited in claim 16, further comprising:
the second wireless communications device comprising:
a second transmitter circuit configured to transmit the first data in the second isochronous data stream and the updated second presentation delay; and
a second receiver circuit configured to receive the request; and
second data processing circuitry configured to generate the updated second presentation delay based on the second presentation delay and the first presentation delay; and
a second delivery device configured to present the first data at the time after transmission of the first data by the first wireless communications device and based on a second timestamp and the updated first presentation delay.

18. The relay network as recited in claim 17, further comprising:
a third wireless communications device comprising:
a third transmitter circuit configured to transmit the first data in a third isochronous data stream and a second request to update the second presentation delay by a third presentation delay of the third wireless communications device; and
a third receiver circuit configured to receive the first data and the updated first presentation delay; and
third data processing circuitry configured to update the third presentation delay to generate an updated third presentation delay based on the updated first presentation delay and the third presentation delay; and
a third delivery device configured to present the first data at the time after transmission of the first data by the third wireless communications device based on a third timestamp and the updated third presentation delay.

19. The relay network as recited in claim 16 wherein the data processing circuitry comprises:
a storage element; and
a processor configured to execute instructions stored in the storage element, the instructions being executable by the processor to cause the processor to update the first presentation delay based on the updated second presentation delay and the first presentation delay.

20. The relay network as recited in claim 16 wherein the updated first presentation delay is greater than or equal to a sum of a transmit delay for each wireless communications device in the relay network and the first data is presented by each wireless communications device in the relay network after transmission of the first data by a last wireless communications device in the relay network.
